(19) United States
(12) Patent Application Publication
(10) Pub. No.: US 2005/0206749 A1
(43) Pub. Date: Sep. 22, 2005

(54) Cellular telephone with digital camera

(75) Inventor: Hiroyuki Miyazaki, Takefu-shi (JP)

Correspondence Address: REED SMITH LLP, Suite 1400, 3110 Fairview Park Drive, Falls Church, VA, 22042, US

(73) Assignee: Orion Electric Company Ltd.

(21) Appl. No.: 11/067,753

(22) Filed: Mar. 1, 2005

(30) Foreign Application Priority Data
Mar. 18, 2004 (JP) 2004-078955

(51) Int. Cl. H04N 5/225

(52) U.S. Cl. 348/231.99

(57) ABSTRACT

This invention provides a cellular telephone with a digital camera that can store data on an image photographed by the digital camera in an internal memory without the need to use a separate service only for storing the image data when a residual capacity of the internal memory is insufficient and, therefore, without the need to make a management necessary to enjoy a separately set service so as to use the separate service. The cellular telephone with a digital camera includes a used memory capacity detecting unit that detects a used capacity of a memory that stores data, a file-attached email transmitting unit that transmits, as a file-attached to an email, the data to an arbitrary mail server with which a user already made a contract, and a unit that activates the file-attached email transmitting unit when the used capacity detected by the used memory capacity detecting unit reaches a predetermined capacity.

### BACKGROUND OF THE INVENTION

1. Field of the Invention

The present invention relates to an automatic data transfer system for a cellular telephone with a digital camera.

2. Description of the Related Art

Patent Literature 1 discloses that if a residual capacity of a memory that stores images photographed by a digital camera is insufficient and an image cannot be stored in the memory any more, then the digital camera communicates with a cellular telephone, the digital camera is automatically connected to a server through the cellular telephone, a guidance for urging image data to be stored in the server is displayed, and image data is transferred from the digital camera to the server so as to store the image data in the server. According to this conventional technique, the transferred image data is erased from a storage memory of the digital camera. A user needs to make a contract with a server service to secure a dedicated backup server. It is, therefore, disadvantageously necessary to use this separately contracted service to access the transferred data.

Patent Literature 2 proposes a provider service that stores data used by a multimedia apparatus in place of a user. According to this proposal, user information transmitted together with the storage target data is naturally compared with registered user data held in a database in a server for authentication. If a user separately uses a data storage service, it is disadvantageously necessary to perform an authentication and prepare a system for the authentication.

Patent Literature 3 discloses a digital camera constituted as follows. If an external memory is not attached to the digital camera or the external memory has no residual capacity, image data is transferred to an external database through a wireless communication circuit and stored in the external database. When the external memory is attached to the digital camera, the image data is automatically stored in the external memory through the wireless communication circuit. This digital camera can temporarily save latest image data in the external database through the wireless communication circuit. However, it is disadvantageously necessary to bear a telecommunication cost and retrieve the image data from the external database only for enabling the user to view the latest image data using this digital camera. It is also disadvantageously necessary to separately manage a capacity of the external memory.

Patent Literature 1: Japanese Patent Application Laid-Open (JP-A) No. 2001-128113

Patent Literature 2: JP-A No. 2001-325218

Patent Literature 3: JP-A No. 2002-171434

### SUMMARY OF THE INVENTION

It is an object of the present invention to provide a cellular telephone with a digital camera that can store data on an image photographed by the digital camera in an internal memory without the need to use a separate service only for storing the image data when a residual capacity of the internal memory is insufficient and, therefore, without the need to make a management necessary for a separately set service so as to use the separate service, differently from the conventional techniques. It is also an object of the present invention to solve the conventional disadvantage in that a user cannot view a latest image using the digital camera, even when a residual capacity of the internal memory is insufficient.

According to a first aspect of the present invention, there is provided a cellular telephone with a digital camera, comprising: a memory that stores image data on an image photographed by the digital camera; and an image transfer unit, wherein the image transfer unit includes: used memory capacity detecting means for detecting a used capacity of the memory that stores the data; file-attached email transmitting means for transmitting, as a file-attached to an email, the data to an arbitrary email server with which a user already made a contract; and means for activating the file-attached email transmitting means when the used capacity detected by the used memory capacity detecting means reaches a predetermined capacity.

According to a second aspect of the present invention, there is provided a cellular telephone with a digital camera, comprising: a memory that stores data on an image photographed by the digital camera; and an image transfer unit, wherein the image transfer unit includes: used memory capacity detecting means for detecting a used capacity of the memory that stores the data; file-attached email transmitting means for transmitting, as a file-attached to an email, the data to an arbitrary email server with which a user already made a contract; means for activating the file-attached email transmitting means when the used capacity detected by the used memory capacity detecting means reaches a first predetermined capacity; and means for deactivating the file-attached email transmitting means when the used capacity detected by the used memory capacity detecting means reaches a second predetermined capacity smaller than the first predetermined capacity.

Moreover, according to a third aspect of the present invention, there is provided a cellular telephone with the digital camera according to the first or second aspect of the invention, wherein the file-attached email transmitting means sequentially transmits the data stored in the memory in a descending order of time.

According to the present invention, image data is transferred and stored using an arbitrary email service with which a user already made a contract without setting a service for transferring and storing the image data. It is, therefore, unnecessary to make a separate contract for transferring and storing the image data.

### BRIEF DESCRIPTION OF THE DRAWINGS

FIG. 1 is a block diagram that depicts a cellular telephone with a digital camera according to an embodiment of the present invention;

FIG. 2 is a typical view of an image transfer setting menu screen according to the embodiment of the present invention;

FIG. 3 is a typical view of a transmission destination address setting menu screen according to the embodiment of the present invention;

FIG. 4 is a typical view of a reference transmission capacity setting menu screen according to the embodiment of the present invention;

FIG. 5 is a typical view of a reference empty capacity setting menu screen according to the embodiment of the present invention;

FIG. 6 is a typical view of an email capacity setting menu screen according to the embodiment of the present invention; and

FIG. 7 is a flowchart that depicts an operation according to the embodiment of the present invention.

### DESCRIPTION OF THE MOST PREFERRED EMBODIMENT

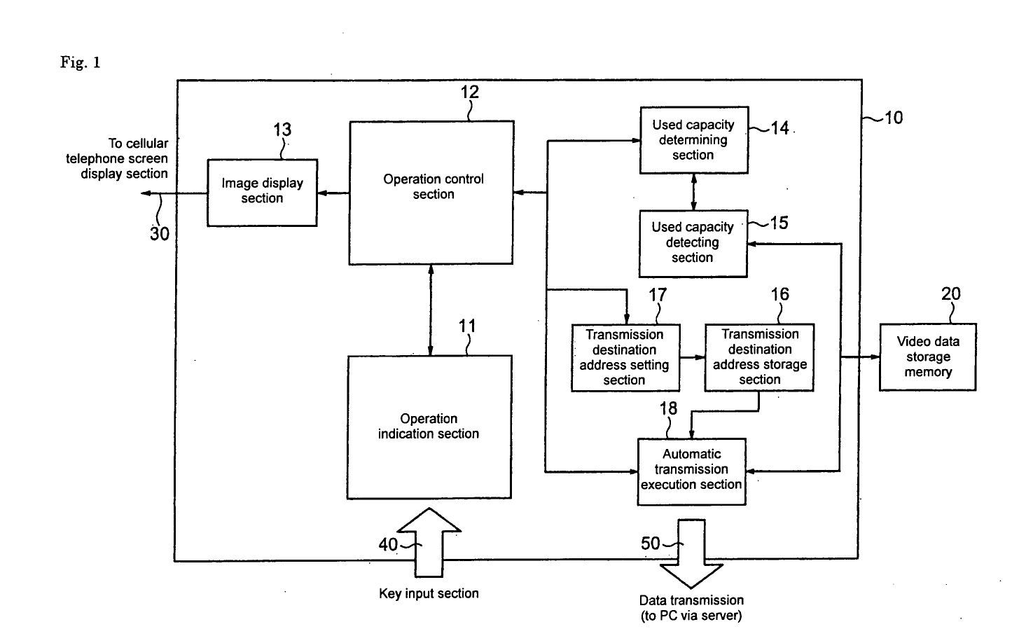

A cellular telephone with a digital camera according to a most preferred embodiment of the present invention is partially shown in a block diagram of FIG. 1. In FIG. 1, reference symbol 10 denotes a microcomputer, 20 denotes a video data storage memory included in the cellular telephone, 30 denotes a line connected to display means of the cellular telephone, 40 denotes a line connected to a keyboard, and 50 denotes a line connected to an email transmitting means incorporated in the cellular telephone.

The microcomputer 10 is programmed to include an operation indication section 11 that indicates various indication signals from main body operation keys connected to the keyboard connection line 40 to respective sections in the microcomputer 10, an operation control section 12 that controls operations of respective operating sections in the microcomputer 10 based on indications from the operation indication section 11, and an image display section 13 that generates to-be-displayed screens according to conditions necessary for the screens such as a used capacity of entire storage mediums including the video data storage memory 20, to be described later, a capacity of a currently used storage medium, and an automatic transmission destination address. This microcomputer 10 also includes a used capacity detecting section 15 that detects the used capacity of the entire storage mediums including the video data storage memory 20, a used capacity determining section 14 that determines what percentage of the storage capacity of the entire storage mediums a used capacity of a data area in which the data is actually recorded is, a transmission destination address setting section 17 that sets a transmit address of a destination to which the data is transmitted (or transferred) when the capacity of the entire storage mediums exceeds a designated capacity, a transmission destination address storage section 16 that stores a plurality of transmission destination addresses and that manages priority order indication data, and an automatic transmission execution section 18 that executes an email transmission via a server only by as much as the designated capacity when the data area used capacity exceeds a preset used capacity.

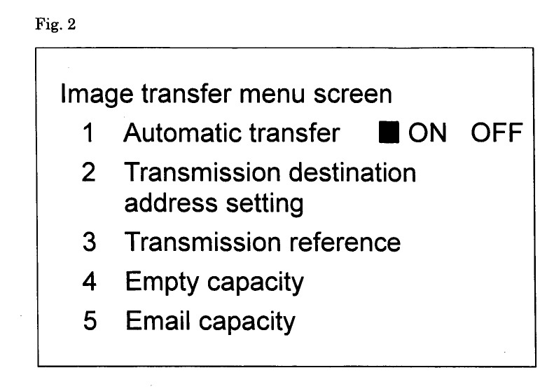

An operation of an image transfer unit constituted as stated above will be described. Settings of this image transfer unit are made as will be described with reference to FIGS. 2 to 6. FIG. 2 depicts a menu screen for making the settings. In FIG. 2, an item 1 on the screen is used to select whether to automatically transfer image data by as much as a designated capacity if a certain capacity of image data is stored in the memory. This image transfer unit is activated only when automatic transfer ON is selected. If so, settings of items tiles of which are displayed on the menu screen as “transmission destination address setting”, “transmission reference”, “empty capacity”, and “email capacity” are also made effective, accordingly.

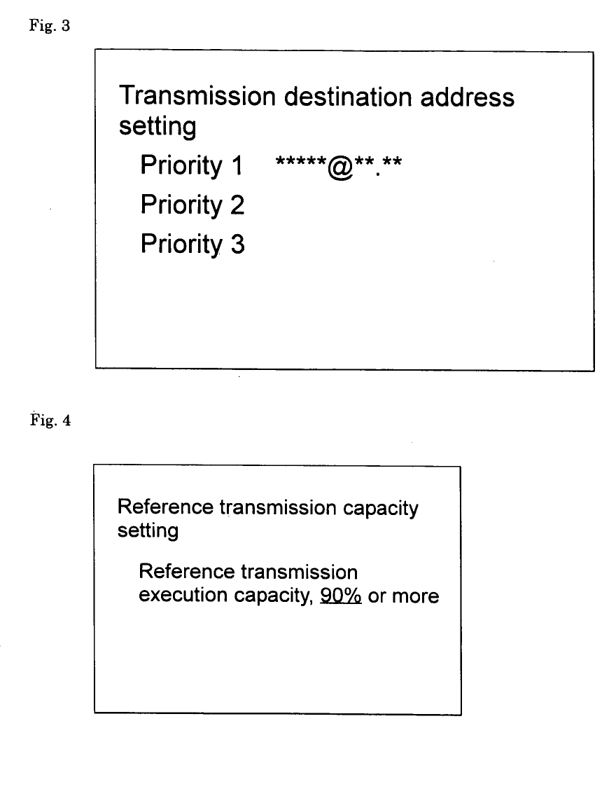

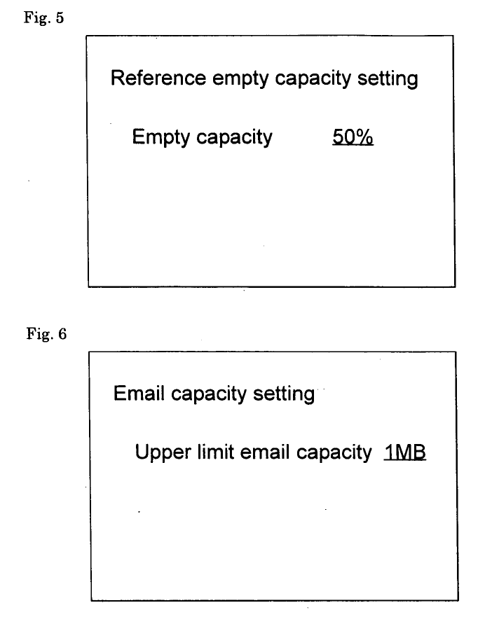

If the user selects the item “transmission destination address setting”, then a screen shown in FIG. 3 appears, and the user can set the transmission destination address by inputting an email address. The user can set a plurality of email addresses with priorities given thereto. If the user selects the item “transmission reference”, then a screen shown in FIG. 4 appears, and the user can set a reference used capacity by as much as which the image data is automatically transferred. The reference used capacity is 90% by default. If the user selects the item “empty capacity”, then a screen shown in FIG. 5 appears, and the user can set an empty capacity to be secured by executing the automatic transfer of the image data. The empty capacity is 50% by default. If the user selects the item “email capacity”, then a screen shown in FIG. 6 appears, and the user can set an upper limit capacity of data that can be attached to one email. The upper limit capacity is one megabyte by default. By setting the email capacity, the user can automatically divide an email into a plurality of emails and transmit the divided emails up to the set transmission capacity.

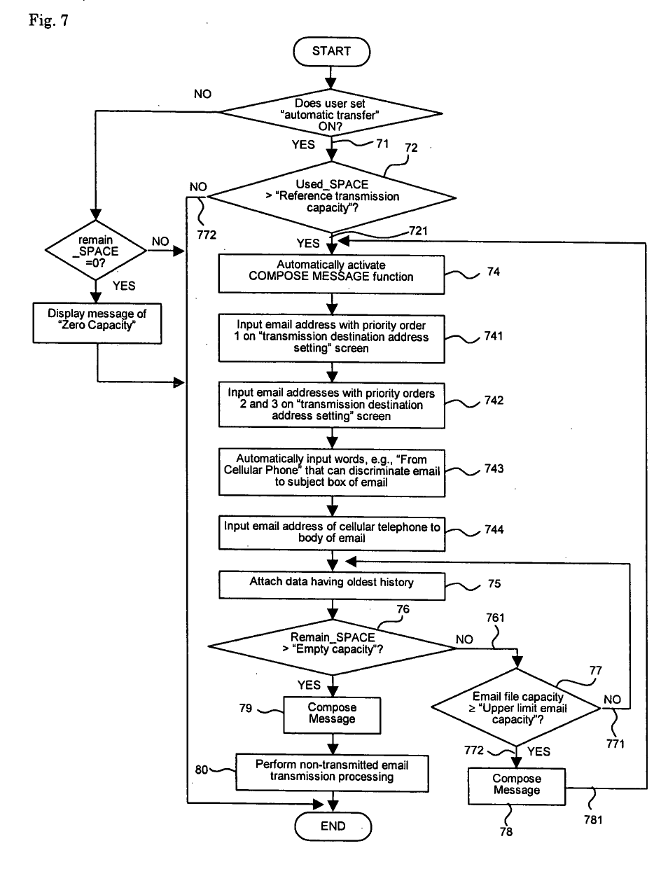

An operation of this automatic transfer unit will be described with reference to a flowchart of FIG. 7. If the user sets the automatic transfer ON (“YES” of a choice 71), the used capacity determining section 14 determines whether the used capacity of the memory used for the image data exceeds the reference transmission capacity at a step 72. If the used capacity determining section 14 determines that the used capacity exceeds the reference transmission capacity (“YES” of a choice 721), the automatic transmission execution section 18 automatically composes a new message for a new email at a step 74. If the used capacity determining section 14 determines that the used capacity does not exceed the reference transmission capacity (“NO” of a choice 722), this automatic transfer unit does not operate.

If the automatic transmission execution section 18 automatically composes a new message for a new email at the step 74, the transmission destination address setting section 17 inputs an email address with a priority 1 recorded in the transmission destination address storage section 16 as an address of the new email at a step 741. Likewise, the transmission destination address setting section 17 inputs email addresses with priorities 2 and 3 as addresses of the new email if they are recorded in the transmission destination address storage section 16 (at a step 742). At a step 743, words, e.g., “From cellular phone” which can discriminate the email are automatically input to a subject box of the email. At a step 744, an email address of the cellular telephone and the like are input to a body of the email. At a step 75, a file of oldest image data among pieces of image data stored in the video data storage memory 20 is attached to the email as an attached file. At a step 76, the used capacity determining section 14 determines whether the residual capacity of the memory is greater than the set empty capacity described above with reference to FIG. 5.

If the used capacity determining section 14 determines at the step 76 that the residual capacity is not greater, that is, smaller than the set empty capacity (“NO” of a choice 761), the used capacity determining section 14 determines at a step 77 whether a capacity of the file-attached to the email is equal to or greater than the set upper limit email capacity described above with reference to FIG. 6. If the used capacity determining section 14 determines that the capacity of the file-attached to the email is not greater, that is, smaller than the set upper limit email capacity (“NO” of a choice 771), a step 75 of further attaching image data to this email is executed. If the used capacity determining section 14 determines at the step 77 that capacity of the file-attached to the email is equal to or greater than the set upper limit email capacity (“YES” of a choice 772), a new email is created (at a step 78) and the operation goes to next email creation procedures (a choice 781).

If the used capacity determining section 14 determines at the step 76 that the residual capacity is greater than the set empty capacity (“YES” of a choice 762), a new email is created at a step 79.

At a step 80, a transmission processing for transmitting the email which has been created but which has not been transmitted yet is performed. The email created at the step 78 is subjected to a processing set for each corresponding mail server since the capacity of the attached file exceeds an attached file capacity limit set to the mail server. If such an image file the capacity of which exceeds the limit is attached to the email, the capacity of the image file to be attached at the step 75 can be reduced at a different step, not shown, as is evident to those skilled in the art.

If the used capacity determining section 14 determines at the step 72 that the used capacity of the image memory is equal to or greater than the reference transmission capacity, this automatic transfer unit starts operating. In addition, the operation of the automatic transfer unit is automatically continued until it is determined at the step 76 that the residual capacity of the image memory is equal to or greater than the set empty capacity. The image data memory of the digital camera incorporated in the cellular telephone can be kept to have a data area margin.

Image files are transferred using an email function of the cellular telephone in a descending order of time. Since a latest image file having a high probability of being viewed and edited is left in the memory included in the digital camera, the user can promptly and easily view and edit the latest image file.

Furthermore, the image data is transferred by being transmitted and received as the file-attached to the email. By setting a personal computer having an email address as a transfer destination, therefore, the stored image data can be easily managed and changed at the transfer destination.

1. A cellular telephone with a digital camera comprising:
the digital camera;
a memory that stores data on an image photographed by the digital camera; and
an image transfer unit, wherein
the image transfer unit includes:
used memory capacity detecting means for detecting a used capacity of the memory that stores the data;
file-attached email transmitting means for transmitting, as a file-attached to an email, the data to an arbitrary email server with which a user already made a contract; and
means for activating the file-attached email transmitting means when the used capacity detected by the used memory capacity detecting means reaches a predetermined capacity.

2. A cellular telephone with a digital camera, comprising:
the digital camera;
a memory that stores data on an image photographed by the digital camera; and
an image transfer unit, wherein the image transfer unit includes:
used memory capacity detecting means for detecting a used capacity of the memory that stores the data;
file-attached email transmitting means for transmitting, as a file-attached to an email, the data to an arbitrary email server with which a user already made a contract;
means for activating the file-attached email transmitting means when the used capacity detected by the used memory capacity detecting means reaches a first predetermined capacity; and
means for deactivating the file-attached email transmitting means when the used capacity detected by the used memory capacity detecting means reaches a second predetermined capacity smaller than the first predetermined capacity.

3. The cellular telephone with the digital camera according to claim 1, wherein
the file-attached email transmitting means sequentially transmits the data stored in the memory in a descending order of time.

4. The cellular telephone with the digital camera according to claim 2, wherein
the file-attached email transmitting means sequentially transmits the data stored in the memory in a descending order of time.
